(19) United States
(12) Patent Application Publication
(10) Pub. No.: US 2023/0011224 A1
(43) Pub. Date: Jan. 12, 2023

(54) ACTUATED COLLAR

(71) Applicants: Dong-Chen HE, Sherbrooke (CA); Li WANG, Sherbrooke (CA)

(72) Inventors: Dong-Chen HE, Sherbrooke (CA); Li WANG, Sherbrooke (CA)

(21) Appl. No.: 17/859,217

(22) Filed: Jul. 7, 2022

Related U.S. Application Data
(60) Provisional application No. 63/220,714, filed on Jul. 12, 2021.

(51) Int. Cl. A01K 27/00

(52) U.S. Cl. CPC A01K 27/001

(57) ABSTRACT

An actuated collar is provided, the actuated collar comprising a pair of straps' ends operatively interconnected to each other via a mechanism adapted to momentarily alter the distance between the each of the straps' ends to reduce the length of the strap to choke an animal.

### CROSS-REFERENCE TO RELATED APPLICATION

This application claims priority from U.S. provisional patent application 63/220,714 filed Jul. 12, 2021, the specification of which is hereby incorporated herein by reference in its entirety.

### FIELD OF THE INVENTION

The present invention generally relates to the field of animal training, focusing on dogs. Specifically, the present invention relates to dog training collar.

### BACKGROUND OF THE INVENTION

Dog training aids have been documented for centuries. Chokers have been proven to be very effective when used correctly. Training a dog while using a choker consist, without going in details, of giving a quick correction (choking) by lightly pulling the leash and then releasing it immediately. This quick tightening around their neck surprises the dogs and cause minor discomfort which deter them from the bad behaviour. Unfortunately, a serious lack of education of many dog handlers is observed. Mishandling of the tool consist of pulling too hard or for too long. Both situations are undesirable and may harm the animal, both physically and mentally.

Then came electrical training collars which send a high voltage impulse through electrodes placed on the collar. Many studies condemn this practice mentioning the same reasons above (too hard, too long and too often corrections) with the addition of pain infliction. An evolution on dog training aids needed to be assessed and better tools need to be developed. An actuated dog collar that reproduces the desired choking action with the practical wireless ability of the usual electrical training collard fills this need.

Furthermore, dog owners forever want to reduce or eliminate dog's barking. Many devices/collars have been invented for this purpose. Briefly, they are using diverse technics: electric static chock, vibration, beeps, ultrasonic, citronella spray, etc. Usually, these devices are triggered by a voice sensor. Once a dog starts to bark, the device sends a static chock, a vibration, a beep, an ultrasonic wave, or a citronella spray.

Not all pets' owners adopt one of these solutions due to some possible psychological harm they may provide to their pets. In addition, these technics are ineffective for most dogs, especially when dogs are excited or with other pets. For some dogs, these devices might get them more dangerous and excited.

Another extreme technic consists of a surgical procedure to mute dog's barking (devocalization, ventriculocordectomy). Many people consider this technic inhuman and cruel.

There is therefore a need for novel devices and technics to provide an aid to dogs' owners in dog training and/or in bark control.

### SUMMARY OF THE INVENTION

The present invention includes many aspects and features. The aforesaid and other objectives of the present invention are realized by generally providing an actuated dog collar apparatus and method of use thereof.

The actuated dog collar simulates the tightening action of the choker while having the practical wireless adaptability of the regular electrocuting collar, without the inflicted pain and preventing most of the misuse or abuse.

At least one aspect of the present invention provides an actuated dog collar that reduce momentarily the total circumference of the collar.

At least one aspect of the invention provides an actuated collar that is remotely operated.

At least one aspect of the invention provides safety features such as a minimal time between corrections.

At least one aspect of the invention uses a pull solenoid to activate the collar and reduce the total circumference.

At least one aspect of the invention uses an electric motor with conjunction of gears to actuate the collar.

At least one aspect of the invention provides an actuated dog collar with different choices of alternative stimulations such as a specific sound or vibration.

At least one aspect of the invention provides an actuated dog collar wherein the mechanism reduces the total circumference of the muzzle part of the collar.

At least one aspect of the invention provides a manually activated collar adapted to momentarily reduce the opening of the muzzle during the time the owner pulls the leash.

In some aspects, the techniques described herein relate to an actuated collar including: an actuation mechanism including a controller; an actuated strap including two extremities operatively interconnected to each other via the actuation mechanism, thereby defining a circumference, the actuation mechanism being adapted to momentarily alter distance between the extremities, thereby momentarily decreasing the circumference of the collar; and a triggering mechanism in connection with the actuation mechanism, adapted to signal the controller to momentarily decrease the circumference of the collar.

In some aspects, the techniques described herein relate to an actuated collar, wherein the trigger mechanism is a sensor.

In some aspects, the techniques described herein relate to an actuated collar, wherein the trigger mechanism is a remote control that is wireless in communication with the controller.

In some aspects, the techniques described herein relate to an actuated collar, wherein the collar includes a collar strap, and a connecting strap connecting the collar strap to the actuated strap.

In some aspects, the techniques described herein relate to an actuated collar, wherein the actuation mechanism includes a solenoid and a plunger, wherein the plunger can be moved between a first position and a second position therefore modifying the circumference of the actuated strap.

In some aspects, the techniques described herein relate to an actuated collar, further including a bracket mounted to the extremity of the actuated strap, wherein the plunger and the bracket are mounted to each other.

In some aspects, the techniques described herein relate to an actuated collar, wherein the actuated strap includes a flexible portion about the bracket.

In some aspects, the techniques described herein relate to an actuated collar, further including an accordion-type enclosure housing the actuation mechanism, the accordion-type enclosure being able to adopt a compressed configuration and an extended configuration.

In some aspects, the techniques described herein relate to an actuated collar, wherein the actuated strap includes a pair of toothed racks, and the actuation mechanism includes a pinion that is adapted to interface with the toothed racks.

In some aspects, the techniques described herein relate to an actuated collar, wherein the toothed racks are coplanar to the actuated strap.

In some aspects, the techniques described herein relate to an actuated collar, wherein the toothed racks include a boss configured to limit displacement of the toothed racks relative to the pinion.

In some aspects, the techniques described herein relate to an actuated collar, further including a motor operatively connected to the pinion.

In some aspects, the techniques described herein relate to an actuated collar, further including an enclosure adapted to house the toothed racks and the pinion both in a compressed configuration and in an extended configuration.

In some aspects, the techniques described herein relate to an actuated collar, further including a LED operatively connected to the controller and configured to generate a light signal indicative of a condition of the actuation mechanism.

In some aspects, the techniques described herein relate to an actuated collar, including a second actuation mechanism including a second controller and operable on a second actuated strap.

In some aspects, the techniques described herein relate to an actuated collar, wherein the trigger mechanism is a remote control that is wireless in also communication with the second controller.

In some aspects, the techniques described herein relate to an actuated collar, wherein the actuation mechanisms are actuatable independently from each other.

In some aspects, the techniques described herein relate to an actuated collar, further including a battery configured to power the actuation mechanism.

In some aspects, the techniques described herein relate to a method of operating an actuated collar, including: having the actuated collar on a dog, including an actuated strap with an actuation mechanism configured to control circumference of the actuated strap between a first circumference and a second circumference; having the actuation mechanism receiving an actuation signal; and having the actuation mechanism operating, thereby modifying the circumference of the actuated strap from the first circumference to the second circumference.

In some aspects, the techniques described herein relate to a method, further including generating the actuation signal through one of a sensor sensing a triggering condition, and a user actuating a remote control.

The features of the present invention which are believed to be novel are set forth with particularity in the appended claims. Other and further aspects and advantages of the present invention will be obvious upon an understanding of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other objects, features and advantages of the invention will become more readily apparent from the following description, reference being made to the accompanying drawings in which:

FIG. 1 is showing a perspective view of an actuated dog collar embodiment;

FIG. 2 is showing a bottom perspective view of an actuated dog collar embodiment;

FIG. 3 is showing a perspective view of the main internal components of an actuated dog collar embodiment;

FIG. 4 is showing a perspective, exploded view of the main internal components of an actuated dog collar embodiment;

FIG. 5 is showing a cross section of the main internal components of an actuated dog collar embodiment;

FIG. 6 is showing an elevational view of an actuated dog collar embodiment, without its enclosure, in its normal or extended state;

FIG. 7 is showing an elevational view of an actuated dog collar embodiment, without its enclosure, in an actuated state;

FIG. 8 is showing a perspective view of another embodiment of an actuated dog collar;

FIG. 9 is showing a front perspective view of the main internal components of an actuated dog collar embodiment;

FIG. 10 is showing a rear perspective, exploded view of the main internal components of an actuated dog collar embodiment;

FIG. 11 is showing a bottom perspective view of an actuated dog collar embodiment, without its enclosure, in a normal or extended state;

FIG. 12 is showing a bottom perspective view of an actuated dog collar embodiment, without its enclosure, in an actuated state;

FIG. 13 is an exemplary flow chart of possible working embodiments of the collar;

FIG. 14 is a perspective view of a dog collar comprising a collar-located chocker and a muzzle-located chocker, and a remote control in communication with the chockers;

FIG. 15 is a perspective view of the collar comprising two interconnected actuation mechanisms, and wherein the collar strap of the collar comprises a plurality of strap components joined with rings, a closable buckle, and an adjustment buckle; and

FIGS. 16A to 16c are schematics of steps involved in putting the collar of FIG. 15 on a dog.

### DETAILED DESCRIPTION

As a preliminary matter, it will be understood by one having ordinary skill in the relevant art (“Ordinary Artisan”) that the invention has broad utility and application. Furthermore, any embodiment discussed and identified as being “preferred” is Considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention discloses herein; only one or a plurality of the features disclosed herein; or combination thereof. As such, many embodiments are implicitly disclosing herein and fall within the scope of what is regarded as the invention.

Accordingly, while the invention is described herein in detail in relation to one or more embodiments, it is to be understood that this disclosure is illustrative and exemplary of the invention and is made merely for purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. II is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention is to be defined by the issued claim(s) rather than the description set forth herein.

Additionally, it is important to note that each term used herein to that which the Ordinary Artisan would understand such term to mean bases on the contextual use of such term herein. To the extent that the meaning of a term used herein-as understood by the Ordinary Artisan based on the contextual use of such term-differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory Provision is intended to and should apply in the interpretation of such claim element. with regard to any method claim including a condition precedent step, such method requires the condition precedent to be met and the step to be performed at least once during performance of the claimed method.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers.” “a picnic basket having crackers without cheese”, and “a picnic basket having both cheese and crackers.” When used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”.

Referring the drawings, one or more preferred embodiments of the invention are next described. The following description of one or more preferred embodiments is merely exemplary in nature and is in no way intended to limit the invention, its Implementations, or uses. Hence, a novel actuated collar in accordance with principles and embodiments of the present invention will be described herein after.

While illustrative and presently preferred embodiment(s) of the invention have been described in detail hereinabove, it is to be understood that the inventive concepts may be otherwise variously embodied and employed and that the appended claims are Intended to be construed to include such variations except insofar as limited by the prior Art.

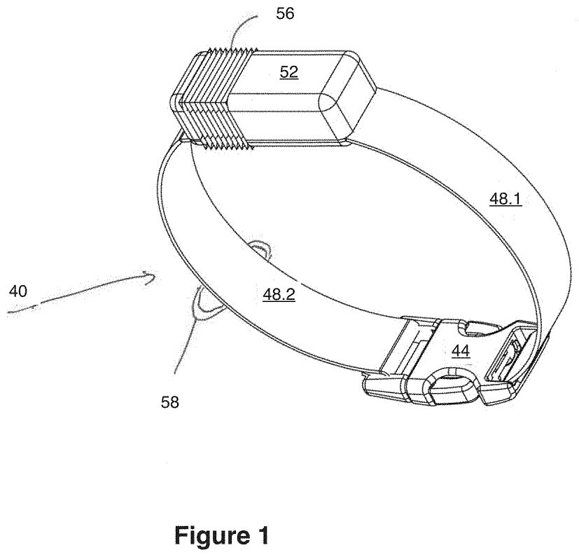

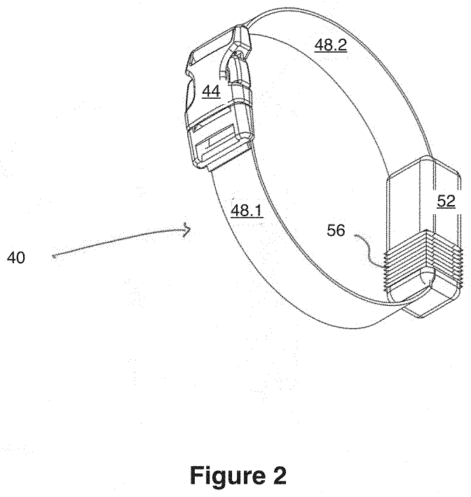

FIG. 1 and FIG. 2 illustrate an actuated dog collar 40, comprising a buckle 44, a collar strap 48, and an enclosure 52 containing the actuation mechanism inside of it. In this embodiment, a collapsible membrane 56, represented as a compressible (an accordion type is illustrated) boot, allow the collar to retract and expand as needed while protecting the internal parts and protecting the animal from the mechanism. The actuated dog collar me also be equipped with an attachment ring 58 for a leash to eliminate the need of a separate collar.

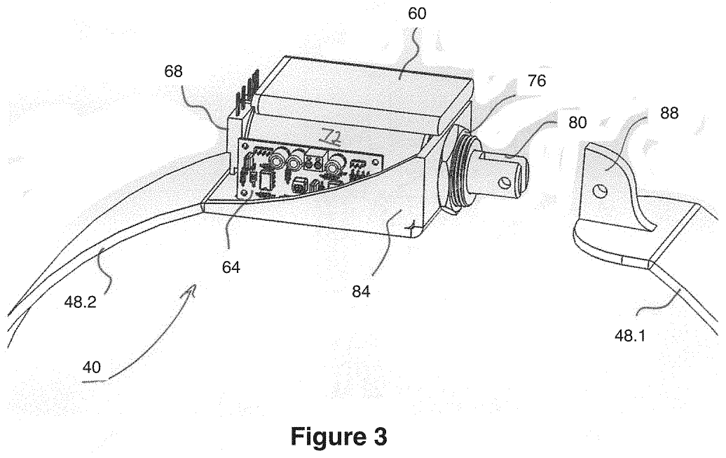

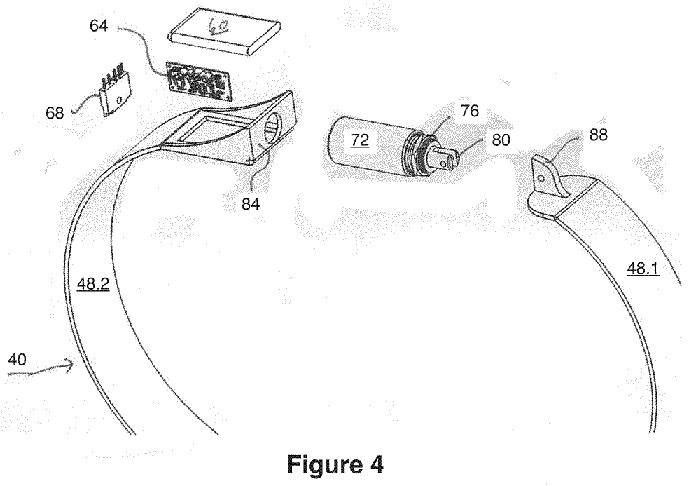

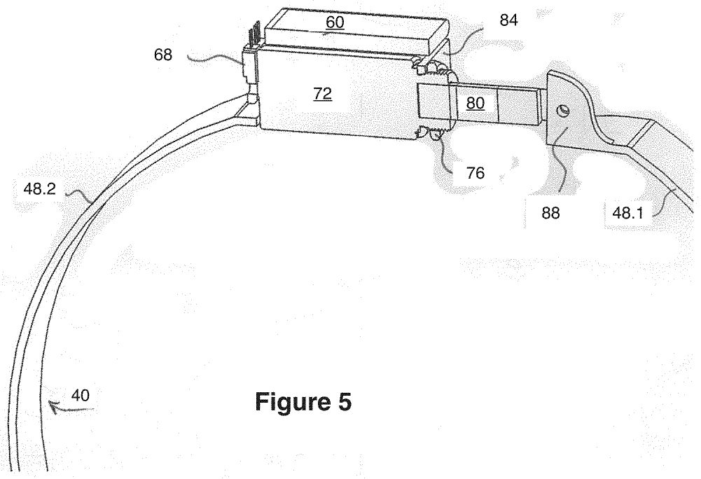

FIGS. 3, 4 & 5 illustrate internal components of the apparatus. The collar strap 48 may be made of composite materials to have a rigid fixation at its ends and have a flexible portion for the animal's comfort, as illustrated in this embodiment. A rigid end of the collar strap 48.2 is formed as a bracket 84 to fasten the solenoid 72 via a nut 76. The solenoid's plunger 80, shown retracted for clarity, is operatively connected to a connector 88 of the collar strap 48.1. The solenoid 72 is electrically connected to the power driver 68. The power driver 68 is also electrically connected to the controller 64 and the battery 60. The controller 64 is powered by the battery 60 and gives signal to the power driver 68 to actuate the solenoid 72 when conditions are met.

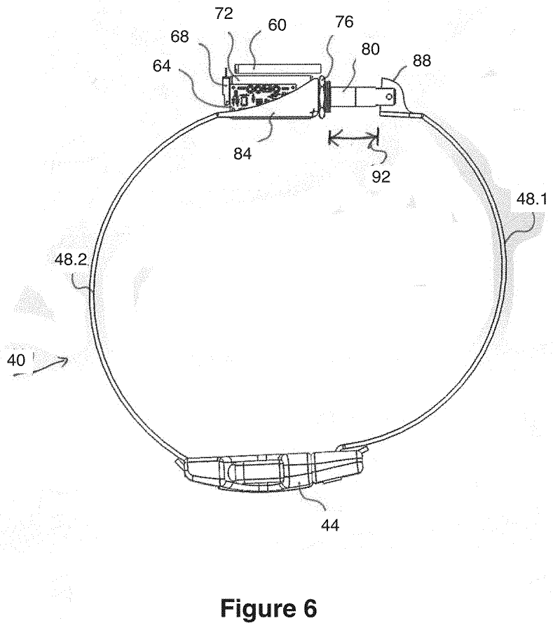

Moving to FIG. 6, where the apparatus is illustrated in its normal position. The solenoid plunger 80, shown in an extended state, is operatively connected to the bracket 88. The distance 92 between brackets 84 & 88 may be restored to the deactivated position of the solenoid's plunger 80 by a low-tension spring (not illustrated), operating as a normal position biasing means. Alternatively or additionally, another low-tension spring (not illustrated) may be used to ease collar adjustment on the animal.

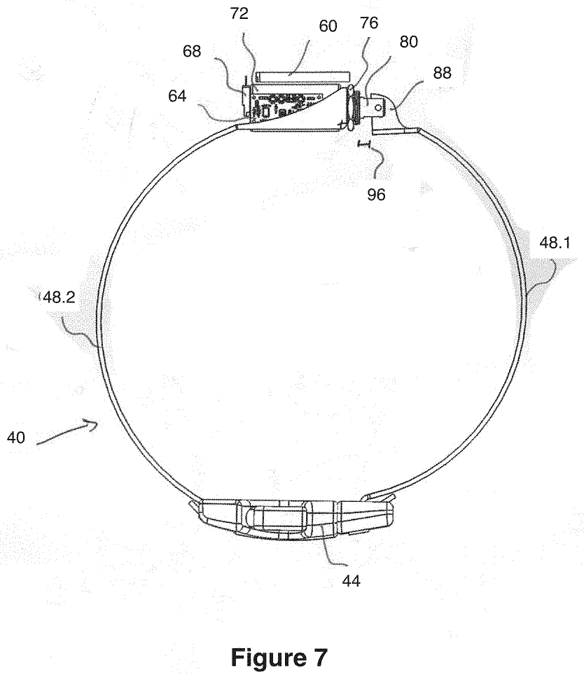

FIG. 7, illustrating the activated dog collar 40, demonstrates the plunger 80, retracted inside the solenoid 72. The distance 96 between brackets 84 and bracket 88 is now reduced hence the total circumference of the collar 40, providing the desired effect. The collar circumference reduction is limited by the stroke of the plunger 80 in the solenoid 72 preventing the usual “overpulling” observed on inexperienced handlers with manual chokers. Different embodiments can use different solenoid 72 pulling forces, depending on the collar size, for example, will also reduce the risk of animal injuries.

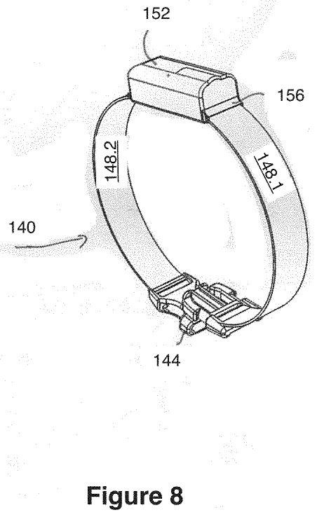

FIG. 8 illustrates another embodiment of the invention. The movement is created through motorization using an electric motor 172 instead of a solenoid. The motorized collar 140 allows different movement speeds for tensioning and releasing the collar and allowing control over the collar pulling force. Seals 156, affixed to the enclosure 152, allow movement of the collar and keep foreign matter such as fur and dirt from entering the enclosure 152 and interfering with the internal moving parts.

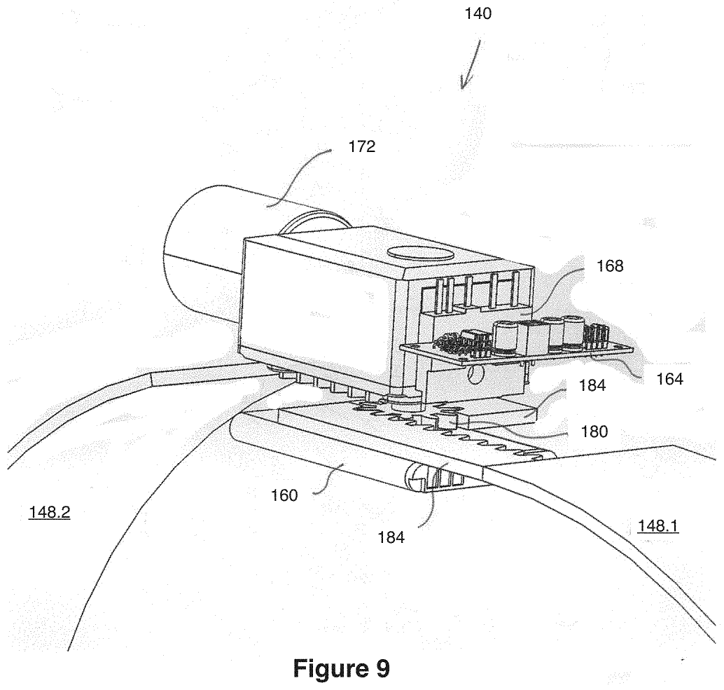

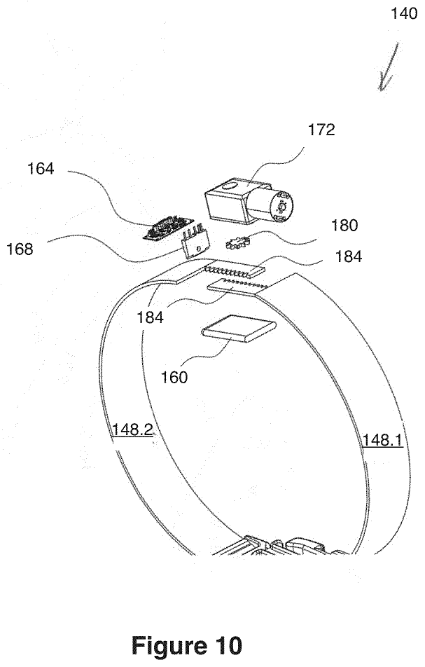

FIGS. 9 & 10 illustrate internal parts of the motorized embodiment. The collar straps 148 may be made of composite materials to have a flexible portion for improved animal's comfort, as well as rigid ends, as illustrated in this embodiment. The rigid ends of the strap 148 form a rack 184 that meshes with a pinion 180. The pinion 180 is operatively connected to the motor and gearbox assembly 172. The motor and gearbox assembly 172 is electrically connected to the power driver 168 which receive operation signals from the controller 164. The battery 160 powers both the controller 164 and the power driver 168.

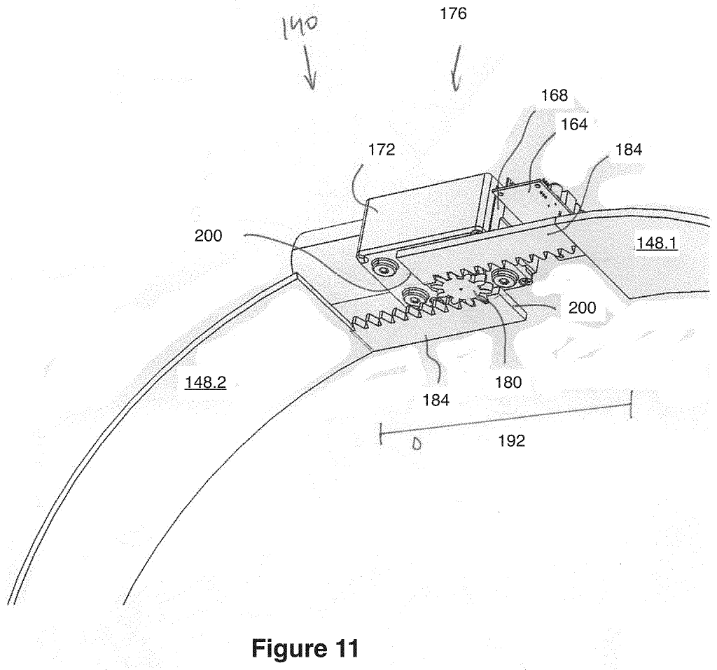

Moving to FIG. 11, the collar 140 is in its extended configuration 176. The controller 164 receives no correction signal from the remote. Two of the pinion gear teeth 182 rest against each rack end bosses 200 so no further extension from the collar 140 is allowed. The extended distance 192 is at its maximum.

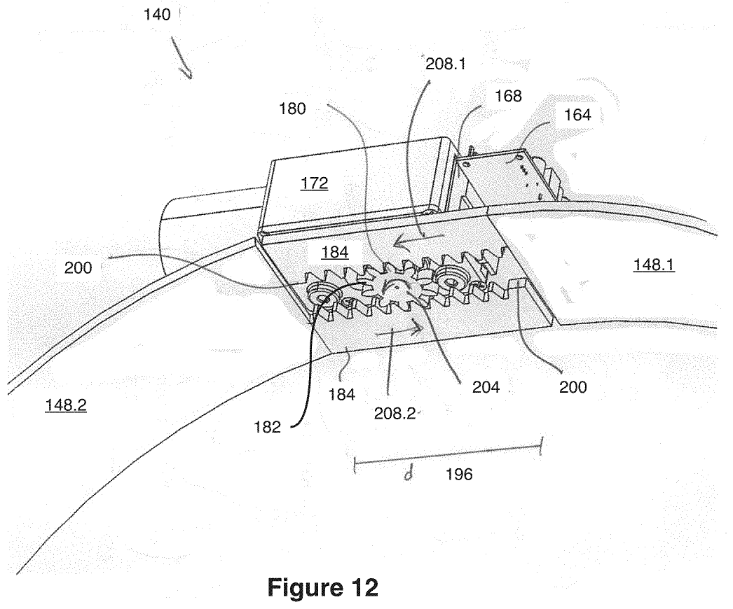

FIG. 12 illustrates the embodiment in its activated configuration. The controller 164 received a correction signal. If conditions are met, the controller 164 gives signal to the power driver 168 to actuate the motor so the pinion 180 rotate in direction 204. The rotation in direction 204 will create linear movements 208.1 & 208.2 of the extremities of the strap 148.1 & 148.2 and thus reduce the total circumference of the collar strap 148.1 & 148.2. The reduced distance achieves the intended effect on the animal. Once the required time has passed, the controller 164 give signal to the power driver 168 to reverse the motor direction so the collar returns to its normal position, until teeth 182 of the pinion 180 rest against the rack bosses 200.

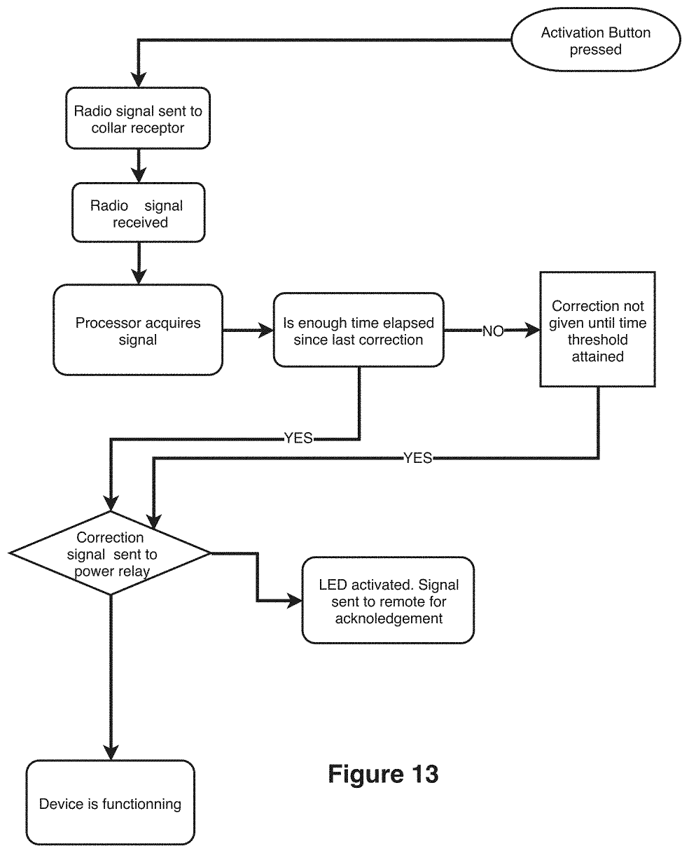

Finally, FIG. 13 is illustrating an exemplary embodiment of a way to actuate the collar 40 or 140. Steps involves comprise the activation of the button on the remote control, resulting in a radio signal being communicated to and received by the controller 64 or 164. It is followed with the signal being processed, fulfillment of operating conditions being evaluated, and the collar 40 or 140 being actuated, thereby modifying the circumference of the strap 48 or 148. The method further comprises a reverse communication from the collar 40 or 140 to the remote for providing feedback on the successful operation.

It is to be noted that the collar 40 or 140 may comprise a LED adapted to visually signal conditions of the collar 40 or 140. For instance, the LED may be adapted to provide a first light signal when operating, a second light signal when encountering a problem, a third light signal when the battery is depleted under a threshold level, etc. wherein each light signal is unique in e.g., the color or the sequence and durations of lit periods.

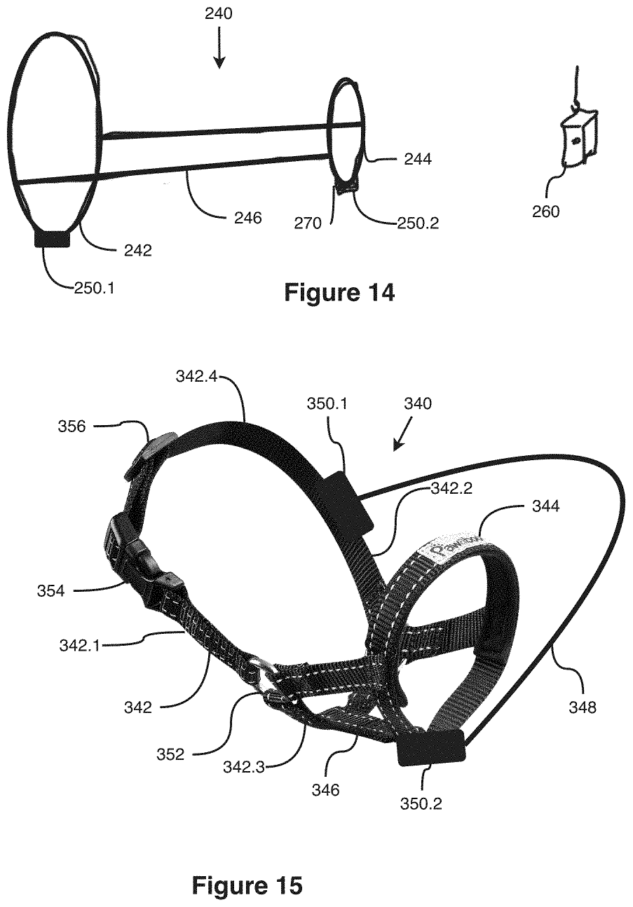

Referring now to FIG. 14, the schematic depicts an embodiment of a collar 240 comprising a collar strap 242 (adjustable to the dog's size), a muzzle strap 244 (adjustable to the dog's size), and connecting straps 246 (adjustable to the dog's muzzle configuration in some embodiments). With this embodiment, two actuation mechanisms 250.1 & 250.2 are present: one controlling the circumference of the collar strap 242 and one controlling the circumference of the muzzle strap 244. The two actuation mechanisms 250.1 & 250.2 are independently actuatable using the remote control 260 allowing to decrease the circumference of the collar strap 242, the muzzle strap 244, or both, temporarily and independently.

The muzzle strap 244 of the collar 240 is designed particularly to control barking of dogs. Typically, the muzzle strap 244 is operatable in three modes:

Mode OFF (Unlock): this mode provides a large circumference to the muzzle strap 244, allowing the dog to freely open the mouth.

Mode ON (Lock): in this mode, the actuation mechanism 250.2 reduces the circumference of the muzzle strap 244, thereby keeping the muzzle strap 244 very tight around the muzzle of the dog so that the dog cannot open the mouth and, in consequence, cannot bark. In this mode, the dog can breathe freely but is prevented to drink or eat through its inability to open its mouth. The duration of this mode must be limited to avoid harming the dog. Such duration is programmable in some embodiments to a maximum period that the owner may cease before the maximum duration is reached.

Mode AUTO: The mode AUTO is triggered when the muzzle strap 244 is in the mode OFF and the sound sensor 270 detects barking over a threshold value. In this mode, the muzzle strap 244 automatically enters in the mode ON for a short duration, e.g., a few minutes, preventing the dog from barking, and restore to the mode OFF/AUTO, restoring the circumference of the muzzle strap 244 to its large circumference.

It is worth noting that in the ON mode the decrease of circumference of the muzzle strap 244 of the collar 240 prevents the dog to open its mouth, preventing both barking and biting, therefore becoming at the same time an anti-biting device.

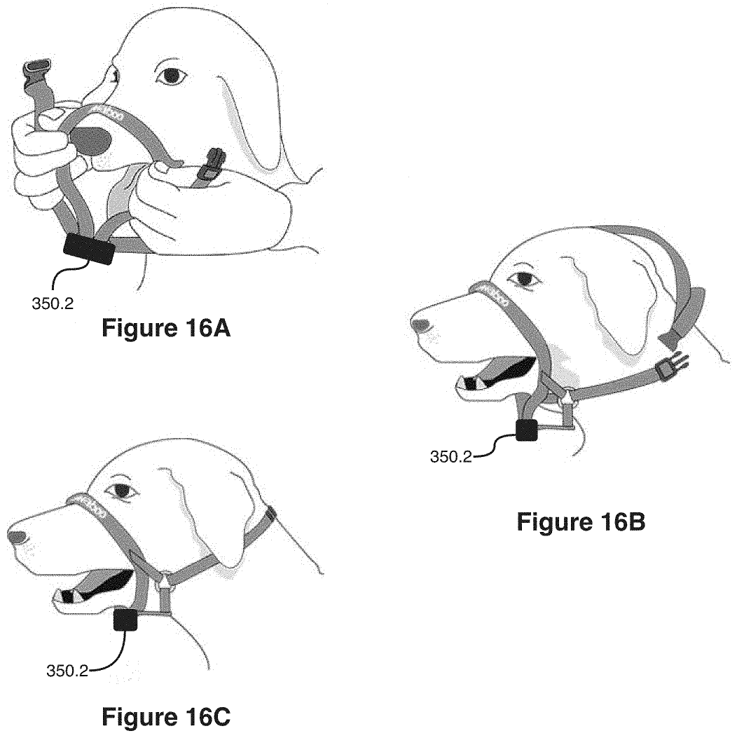

Referring to FIGS. 15 and 16A-16C, an embodiment of a collar 340 wherein the collar strap 342 comprises a plurality of collar strap components 342.1, 342.2, 342.3 & 342.4 joined with rings 352, a closable buckle 354 and an adjustment buckle 356. The collar strap 342 therethrough as illustrated through that example, can have an irregular path, and follow the neck close to the crane of the dog at the rear and below the jaws at the junction of the jaws and the throat at the front.

According to an embodiment, a first actuation mechanism 350.1 may be located on one of the collar strap components 342.1-4. The second actuation mechanism 350.2 is located on the muzzle strap 344.

According to an embodiment that may be illustrated through FIG. 15, the first actuation mechanism 350.1 encloses the battery, while the second actuation mechanism 350.1 do not, lightening collar 340 about the muzzle therethrough. A cable 348 connects the first actuation mechanism 350.1 and the second actuation mechanism 350.2, either being used only to power the second actuation mechanism 350.2, or power and control the second actuation mechanism 350.2.

According to another embodiment that may be illustrated through FIG. 15, the first actuation mechanism 350.1 encloses the battery and a controller, while the second actuation mechanism 350.1 do not, lightening collar 340 about the muzzle even more. A gained cable 348 connecting the first actuation mechanism 350.1 to the second actuation mechanism 350.1 permits to the first actuation mechanism 350.1 to mechanically control the second actuation mechanism 350.2, and thus centralize most of the components into the first actuation mechanism 350.1.

It is to be noted that even though the electric cable/gained cable 348 is depicted loose between the first and second actuation mechanism 350.1 & 350.2, the electric cable/gained cable 348 can be secured to the straps 342, 344 & 346 to ensure that it will not be accidently snatched.

Referring to FIGS. 16A to 16C, the method of putting a collar (e.g., collar 340, first actuatable mechanism 350.1 not depicted) to a dog comprises the following steps. FIG. 16A depicts adjusting the collar strap, and placing on and locking the buckle. FIG. 16B depicts positioning the nose strap. FIG. 16C depicts adjusting the collar to the optimal width, ensuring that the circumferences are set to avoid providing discomfort to the dog when the actuation mechanisms 350.1 & and 350.2 are deactivated, and that, one activated, the decrease of the circumferences provides the desired result without harming the dog.

It is to be noted that, according to embodiments, putting on a collar may comprise less steps. It may further comprise steps associated with verifying and setting up the actuation mechanism, e.g., setting up the circumference of the straps with the actuation mechanism in the extended position, verifying battery, verifying remote communication, etc.

Additional and further embodiments can appear obvious to a skilled reader in light of this patent specification and these embodiments are considered to be fully within the scope of the invention.

What is claimed is:

1. An actuated collar comprising:
an actuation mechanism comprising a controller;
an actuated strap comprising two extremities operatively interconnected to each other via the actuation mechanism, thereby defining a circumference, the actuation mechanism being adapted to momentarily alter distance between the extremities, thereby momentarily decreasing the circumference of the collar; and
a triggering mechanism in connection with the actuation mechanism, adapted to signal the controller to momentarily decrease the circumference of the collar.

2. The actuated collar of claim 1, wherein the trigger mechanism is a sensor.

3. The actuated collar of claim 1, wherein the trigger mechanism is a remote control that is wireless in communication with the controller.

4. The actuated collar of claim 1, wherein the collar comprises a collar strap, and a connecting strap connecting the collar strap to the actuated strap.

5. The actuated collar of claim 1, wherein the actuation mechanism comprises a solenoid and a plunger, wherein the plunger can be moved between a first position and a second position therefore modifying the circumference of the actuated strap.

6. The actuated collar of claim 5, further comprising a bracket mounted to the extremity of the actuated strap, wherein the plunger and the bracket are mounted to each other.

7. The actuated collar of claim 6, wherein the actuated strap comprises a flexible portion about the bracket.

8. The actuated collar of claim 1, further comprising an accordion-type enclosure housing the actuation mechanism, the accordion-type enclosure being able to adopt a compressed configuration and an extended configuration.

9. The actuated collar of claim 1, wherein the actuated strap comprises a pair of toothed racks, and the actuation mechanism comprises a pinion that is adapted to interface with the toothed racks.

10. The actuated collar of claim 9, wherein the toothed racks are coplanar to the actuated strap.

11. The actuated collar of claim 9, wherein the toothed racks comprise a boss configured to limit displacement of the toothed racks relative to the pinion.

12. The actuated collar of claim 9, further comprising a motor operatively connected to the pinion.

13. The actuated collar of claim 9, further comprising an enclosure adapted to house the toothed racks and the pinion both in a compressed configuration and in an extended configuration.

14. The actuated collar of claim 1, further comprising a LED operatively connected to the controller and configured to generate a light signal indicative of a condition of the actuation mechanism.

15. The actuated collar of claim 1, comprising a second actuation mechanism comprising a second controller and operable on a second actuated strap.

16. The actuated collar of claim 15, wherein the trigger mechanism is a remote control that is wireless in also communication with the second controller.

17. The actuated collar of claim 15, wherein the actuation mechanisms are actuatable independently from each other.

18. The actuated collar of claim 1, further comprising a battery configured to power the actuation mechanism.

19. A method of operating an actuated collar, comprising:
having the actuated collar on a dog, comprising an actuated strap with an actuation mechanism configured to control circumference of the actuated strap between a first circumference and a second circumference;
having the actuation mechanism receiving an actuation signal; and
having the actuation mechanism operating, thereby modifying the circumference of the actuated strap from the first circumference to the second circumference.

20. The method of claim 19, further comprising generating the actuation signal through one of a sensor sensing a triggering condition, and a user actuating a remote control.
